(19) United States
(12) Patent Application Publication
(10) Pub. No.: US 2015/0309938 A1
(43) Pub. Date: Oct. 29, 2015

(54) USING FREQUENCY TRIGGERING WITH PASSIVE COMPONENTS TO GENERATE RESET

(71) Applicant: Compellent Technologies, Eden Prairie, MN (US)

(72) Inventors: Preeth Kartikeyan Srinivasan, Round Rock, TX (US); Anthony H. Anconetani, Round Rock, TX (US)

(73) Assignee: Compellent Technologies, Eden Prairie, MN (US)

(21) Appl. No.: 14/259,353

(22) Filed: Apr. 23, 2014

(51) Int. Cl. G06F 12/08

(52) U.S. Cl. CPC G06F 12/0891

(57) ABSTRACT

A method for resetting a data storage drive in a drive system. The method may include transmitting a first signal at a first frequency to a GPIO connector pin corresponding to the data storage drive, utilizing a passive circuit to filter out the first signal, the filtered signal triggering a passive logic circuit to generate an output, and transmitting the output to a drive reset pin on a data storage drive so as to reset the data storage drive. In some cases, the first signal may be initiated from a location remote from the data storage drive. In additional or alternative embodiments, the method may include monitoring a parameter of the data storage drive, the data storage system, and/or a connection therebetween. The first signal may be initiated when a predetermined condition, based, at least in part, on the monitored parameter, is satisfied.

### FIELD OF THE INVENTION

The present disclosure relates to generating drive resets. Particularly, the present disclosure relates to using electronic signals and passive components to reset individual drives within a data storage system.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One type of information handling systems, data storage systems, including but not limited to disk drive systems and solid state drive systems or combinations thereof, having one or more data storage drives or devices, may sometimes require a reset of one or more of the drives, individually. For example, often, when a consumer experiences technical issues with a data storage system, such as a disk drive system, a reset of one or more drives in the system may be a problem-solving first step. In this regard, consumers, users, controllers, or technicians may wish to restart an individual drive either locally or remotely. In some cases, consumers, users, controllers, or technicians may alternately desire a system for automatically resetting drives when certain parameters within the drive are met, often referred to as a watchdog reset. Existing reset methods and systems, however, require the addition of active components to a passive system backplane, or adding pins or other components across the controller and backplane interface. The addition of these components to the disk drive system increases the cost of implementing the reset device and can lead to single point of failure issues.

Thus, there is a need in the art for improved systems and methods for resetting individual drives in data storage systems either remotely or automatically. Particularly, there is a need in the art for systems and methods for using passive components to remotely or automatically reset individual drives in data storage systems, such as but not limited to disk drives and solid state drives.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one embodiment, relates to a method for resetting a data storage drive in a drive system. The method may include transmitting a first signal at a first frequency to a general purpose input/output (GPIO) connector pin corresponding to the data storage drive, utilizing a passive circuit to filter out the first signal, the filtered signal triggering a passive logic circuit to generate an output, and transmitting the output to a drive reset pin on a data storage drive so as to reset the data storage drive. The method may also include transmitting a second signal at a second frequency to the GPIO connector pin for a purpose other than resetting the data storage drive. In some cases, the first signal may be initiated from a location remote from the data storage drive. In still further embodiments, the first signal may be manually initiated by a user at a location remote from the data storage drive. In particular embodiments, the method may also include monitoring a parameter of the data storage drive, the data storage system, and/or a connection therebetween. The first signal may be initiated when a predetermined condition, based, at least in part, on the monitored parameter, is satisfied.

The present disclosure, in another embodiment, relates to an information handling system. The system may include a data storage drive, a GPIO connector pin for communication with a GPIO drive pin on the data storage drive, a passive circuit that filters out a signal at a first frequency from communication sent to the GPIO connector pin, and a passive logic block in communication with a drive reset pin of the data storage drive and triggered by the filtered signal to output a reset signal to the drive reset pin. In some embodiments, the signal at the first frequency may be initiated from a location remote from the data storage drive. The GPIO connector pin may be configured, in some embodiments, for additionally communicating at a second frequency for a purpose other than resetting the data storage drive. The system may further include a module for monitoring a parameter of the data storage drive, the information handling system, and/or a connection therebetween. The signal at the first frequency may be initiated when a predetermined condition, based, at least in part, on the monitored parameter, is satisfied.

The present disclosure, in still another embodiment, relates to a passive circuit having a filter that receives communication and filters out a signal at a predetermined frequency and a logic circuit that is triggered by the filtered signal at the predetermined frequency, the logic circuit generating an output, based at least in part on the filtered signal, that is transmitted to a drive reset pin on a data storage drive. In some embodiments, the filter may be a high pass filter, configured to filter out signals within a particular relatively high frequency range.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a schematic diagram of a system configuration suitable for the methods of using passive components to reset drives in data storage systems in accordance with the various embodiments of the present disclosure.

FIG. 2 is a schematic diagram of a data storage system that may benefit from the systems and methods for resetting drives of the present disclosure.

### DETAILED DESCRIPTION

The present disclosure relates to novel and advantageous systems and methods for resetting an individual storage drive or device in a data storage system. Particularly, the present disclosure relates to using passive components to reset individual storage drives or devices in a data storage system.

For purposes of this disclosure, any system or information handling system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a personal computer (e.g., desktop or laptop), tablet computer, mobile device (e.g., personal digital assistant (PDA) or smart phone), server (e.g., blade server or rack server), a network storage device, or any other suitable device or combination of devices and may vary in size, shape, performance, functionality, and price. A system may include random access memory (RAM), one or more processing resources such as a central processing unit (CPU) or hardware or software control logic, ROM, and/or other types of nonvolatile memory. Additional components of a system may include one or more disk drives or one or more mass storage devices, one or more network ports for communicating with external devices as well as various input and output (I/O) devices, such as a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, or any combination of storage devices. A system may include what is referred to as a user interface, which may generally include a display, mouse or other cursor control device, keyboard, button, touchpad, touch screen, microphone, camera, video recorder, speaker, LED, light, joystick, switch, buzzer, bell, and/or other user input/output device for communicating with one or more users or for entering information into the system. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices. A system may also include one or more buses operable to transmit communications between the various hardware components.

One or more programs or applications, such as a web browser, and/or other applications may be stored in one or more of the system data storage devices. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information.

Hardware and software components of the present disclosure, as discussed herein, may be integral portions of a single computer or server or may be connected parts of a computer network. The hardware and software components may be located within a single location or, in other embodiments, portions of the hardware and software components may be divided among a plurality of locations and connected directly or through a global computer information network, such as the Internet.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by hardware components, computer-executable program code portions, or combinations thereof. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

As indicated above, an information handling system of the present disclosure may be or include a data storage system, including but not limited to including only, one or more disk drives and/or solid state storage devices. As further described above, situations may often arise where it may be desirable to reset one or more drives in a data storage system or a reset may be otherwise attempted or utilized to resolve an issue with the drive. For example, when a consumer or operator is experiencing a technical issue with a data storage system, in many cases, a reset of one or more of its corresponding drives may resolve the issue. Therefore, it can be desirable to perform a reset of one or more drives before attempting further maintenance or investigation into the technical issue. Generally, in various embodiments of the present disclosure, a data storage system, such as for example a disk drive system, may be configured to receive a signal at a particular frequency that, using passive components, triggers a drive reset or other operation. The signal may be sent manually or automatically and may be sent locally or remotely.

A data storage drive or device may include a connector having a plurality of input/output pins that perform various functions at certain operating frequencies. One or more of these pins (referred to herein as drive pins) may be designated a general purpose input/output (GPIO) pin, that generally has no special purpose defined by the manufacturer and is generally unused by default. The drive may connect with the rest of the system by means of a system connector correspondingly comprising a plurality of input/output pins (referred to herein as connector pins) configured for mating with the drive pins, allowing communication between the rest of the system, comprising for example a drive controller, and the drive. In some cases, end users may define a purpose for an available GPIO pin, such as for example, to drive a status/activity LED, or to relay some other information. According to some embodiments of the present disclosure, a GPIO connector pin on a system connector may be purposed, repurposed (from one purpose to another), or in other embodiments, assigned a second purpose (i.e., dual purposed or multi-purposed), so that the GPIO connector pin may support a signal at a particular frequency instead of or in addition to the frequencies on which the pin otherwise operates to perform general functions. For example, where a GPIO connector pin communicates signals at a first frequency for performing a first purpose, the pin may additionally be assigned a second purpose and configured to support signals of a second frequency, different than the first frequency, for that purpose. At any rate, a passive circuit may be used to receive and filter out signals at the particular frequency and trigger a specific operation, such as but not limited to a reset of the drive.

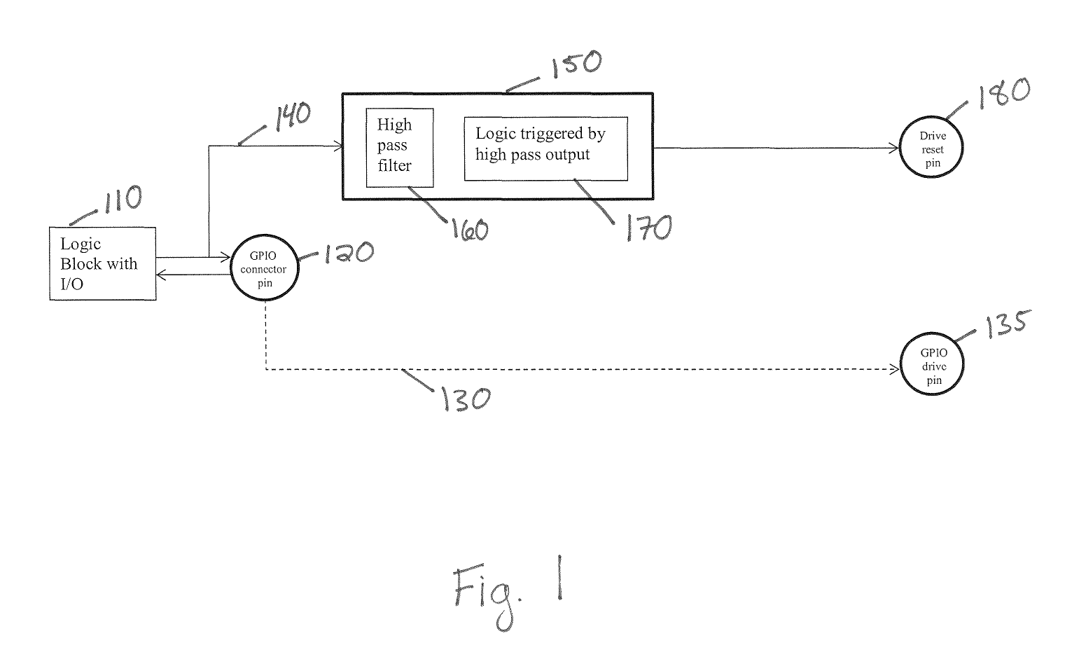

FIG. 1 schematically illustrates a system configuration suitable for the methods of resetting a drive in accordance with some embodiments of the present disclosure. The system 100 may include a logic block with input/output (I/O) capability 110 in communication with a GPIO connector pin 120 on a system connector having a plurality of I/O pins. In an embodiment, the GPIO connector pin 120 may be purposed, repurposed, or dual purposed for identifying a signal at a particular frequency, such as but not limited to, a relatively high frequency signal 140. Where the GPIO connector pin 120 is defined for dual purposes, the logic block 110 may generally communicate with the pin 120 at a target or normal operating frequency 130, which may be forwarded, as usual, to a GPIO drive pin 135 on a drive connector for conventional purposes, which will not be described in detail herein but will be understood by those skilled in the art. In addition to the communication at the normal operating frequency 130, according to some embodiments of the present disclosure, the logic block 110 may also communicate at another frequency, such as but not limited to a relatively high frequency 140 with the dual purposed GPIO connector pin 120. Where the GPIO connector pin 120 is simply purposed or repurposed (i.e., having no dual purpose), the logic block 110 may, in some cases, communicate with the GPIO connector pin 120 solely at a single predetermined frequency corresponding to the purposes described herein, such as to generate a drive reset.

In some embodiments, the predetermined frequency or other/second frequency (in the case of a dual purposed pin) signal 140 may originate within another component of the data storage system, for example, when one or more predetermined conditions are satisfied based, for example, on the monitoring of one or more parameters of the drive, data storage system, the connection therebetween, a corresponding network, or other suitable parameter or parameters. In other embodiments, the predetermined frequency or other/second frequency signal 140 may be manually initiated by a user or operator either local to or remote from the drive. Where the predetermined frequency or other/second frequency signal 140 is prompted by a remote user or operator, the signal 140 may be communicated over a network, such as but not limited to a local area network (LAN), wide area network (WAN), such as the Internet, or any other suitable communications network, wired or wireless to the logic block 110 and/or GPIO connector pin 120. When the logic block 110 communicates the signal 140 to the GPIO connector pin 120, the signal 140 may be received or intercepted by a passive circuit 150 that filters out the predetermined frequency or other/second frequency signal 140 through, for example, a high or low pass filter 160 or the like and triggers logic 170 that has been configured to perform a predetermined operation. In some embodiments, the logic 170 may be configured to trigger a drive reset. In further embodiments, the passive circuit 150, therefore, may be operably connected with a drive reset pin 180 of the drive connector and operate to send a signal to the drive reset pin to cause a reset of the drive. In other embodiments, the operation triggered may be any other drive-specific operation. In still other embodiments, the operation triggered may be any suitable drive, system, or network operation, and the present disclosure is not limited to solely generating drive resets. Indeed, such frequency triggering may be used in any type of information handling system to trigger any type of operation passively.

In still further embodiments, the GPIO connector pin 120 may additionally be purposed to receive any suitable number of additional signals at various other predetermined frequencies. A passive circuit, similar to that described above, may be correspondingly provided for each signal frequency and communicatively coupled with the GPIO connector pin 120. As a result, when the logic block 110 communicates a signal at a particular predetermined frequency to the GPIO connector pin 120, that signal may be intercepted by the corresponding passive circuit, out of a plurality of passive circuits, for filtering out the predetermined frequency and triggering logic that has been configured to perform a predetermined operation. In this regard, a GPIO connector pin may be multi-purposed for performing a plurality of operations, depending on the frequency of the signal transmitted to the GPIO connector pin.

Generally, the systems and methods described in this disclosure for using a signal at a predetermined frequency to trigger a certain operation within a disk drive system involve a combination of existing, conventional drive components and additional passive components, such as passive circuit 150. In this regard, no additional active circuits nor additional pins are required to perform the frequency triggered operations described herein. The use of existing, available components and the additional passive components to send a triggering frequency can avoid the cost associated with adding active components, pins, or other components to the drive system. It also may avoid or mitigate single point of failure issues that could occur with the addition of active components.

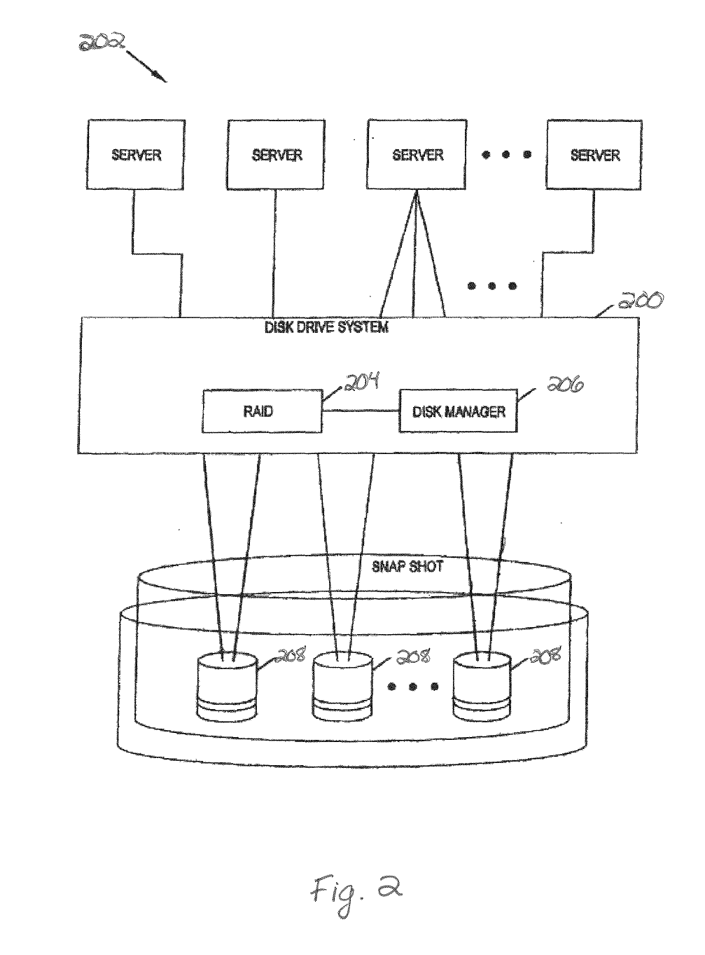

FIG. 2 illustrates one embodiment of a disk drive or data storage system 200 in an information handling system environment 202, such as that disclosed in U.S. Pat. No. 7,613,945, suitable for the various embodiments of the present disclosure. As shown in FIG. 2, the disk drive system 200 may include a data storage subsystem 204, which may include, but is not limited to, a RAID subsystem, as will be appreciated by those skilled in the art, and a disk manager 206 having at least one disk storage system controller. The data storage subsystem 204 and disk manager 206 can dynamically allocate data across disk space of a plurality of disk drives or other suitable storage devices 208, such as but not limited to optical drives, solid state drives, tape drives, etc., based on, for example, RAID-to-disk mapping or other storage mapping technique. The data storage subsystem 204 may include data storage devices distributed across one or more data sites at one or more physical locations, which may be network connected. Any of the data sites may include original and/or replicated data (e.g., data replicated from any of the other data sites) and data may be exchanged between the data sites as desired. In such systems, or other disk drive systems, the various embodiments of the present disclosure may, for example, be utilized to reset individual disk drives within the system.

In the foregoing description, various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

We claim:

1. A method for resetting a data storage drive in a drive system, the method comprising:
transmitting a first signal at a first frequency to a GPIO connector pin corresponding to the data storage drive;
utilizing a passive circuit to filter out the first signal, the filtered signal triggering a passive logic circuit to generate an output; and
transmitting the output to a drive reset pin on a data storage drive so as to reset the data storage drive.

2. The method of claim 1, further comprising transmitting a second signal at a second frequency to the GPIO connector pin for a purpose other than resetting the data storage drive.

3. The method of claim 1, wherein the first signal is initiated from a location remote from the data storage drive.

4. The method of claim 3, wherein the first signal is manually initiated by a user at a location remote from the data storage drive.

5. The method of claim 1, further comprising monitoring a parameter of at least one of the data storage drive, the data storage system, and a connection therebetween.

6. The method of claim 5, further comprising initiating the first signal when a predetermined condition, based, at least in part, on the monitored parameter, is satisfied.

7. An information handling system comprising:
a data storage drive;
a GPIO connector pin for communication with a GPIO drive pin on the data storage drive;
a passive circuit that filters out a signal at a first frequency from communication sent to the GPIO connector pin; and
a passive logic block in communication with a drive reset pin of the data storage drive and triggered by the filtered signal to output a reset signal to the drive reset pin.

8. The information handling system of claim 7, wherein the GPIO connector pin is configured for communicating at a second frequency, in addition to the first frequency, for a purpose other than resetting the data storage drive.

9. The information handling system of claim 7, wherein the signal at the first frequency is initiated from a location remote from the data storage drive.

10. The information handling system of claim 7, further comprising a module for monitoring a parameter of at least one of the data storage drive, the information handling system, and a connection therebetween.

11. The information handling system of claim 10, wherein the signal at the first frequency is initiated when a predetermined condition, based, at least in part, on the monitored parameter, is satisfied.

12. A passive circuit comprising:
a filter that receives communication and filters out a signal at a predetermined frequency; and
a logic circuit that is triggered by the filtered signal at the predetermined frequency, the logic circuit generating an output, based at least in part on the filtered signal, that is transmitted to a drive reset pin on a data storage drive.

13. The passive circuit of claim 12, wherein the filter is a high pass filter, configured to filter out signals within a particular relatively high frequency range.
